(19) United States
(12) Patent Application Publication
(10) Pub. No.: US 2020/0025370 A1
(43) Pub. Date: Jan. 23, 2020

(54) Mobile Multiple Torch Apparatus

(71) Applicant: Anthony Romano, Dyer, IN (US)

(72) Inventor: Anthony Romano, Dyer, IN (US)

(21) Appl. No.: 16/040,885

(22) Filed: Jul. 20, 2018

(51) Int. Cl. F23D 14/38; F23D 14/28; F23Q 9/14; F16K 17/36

(52) U.S. Cl. CPC F23D 14/38; F16K 17/36; F23Q 9/14; F23D 14/28

(57) ABSTRACT

A mobile multiple torch assembly suitable for use in recreational applications such as patios, decks, or a variety of outdoor settings that allows greater control over the amount of light, heat and emissions and can more readily be moved to different locations, and that optionally and preferably includes safety features intended to shut-off the flow of flammable gas in the event a flame is not detected or the torch assembly tips over.

### CROSS REFERENCE TO RELATED APPLICATIONS

Not applicable.

### BACKGROUND OF THE INVENTION

### 1. Field of the Invention

The present invention is related to torches, and more particularly to torches which may be used in recreational environments such as with patios, decks, or a variety of outdoor settings.

### 2. Description of Related Art

A variety of outdoor settings often include a torch for a variety of reasons, including for lighting, for heat, for bugs and for ambience. A conventional torch often involves a single burner head atop a single support, which support is often times embedded in the ground or otherwise affixed to a nearby surface. It would be advantageous, however, to have a multiple burner head torch apparatus that would allow greater control over the amount of light, heat and emissions and would be more readily moved to different locations, including locations having harder surfaces where embedding support structures in the ground may prove more difficult.

### BRIEF SUMMARY OF THE INVENTION

The present invention is directed to an apparatus that satisfies this need. The apparatus comprises three burner heads that allows greater control over the amount of light, heat and emissions and is mounted on a base assembly that allows the torch apparatus to be readily moved to different locations

Some optional features include ignitors, pole connectors and wheels, and additional safety feature such as no-flame shut-off valves and not-level shut-off valves.

Some of the advantages of the invention include greater mobility and greater control over the amount of light, heat and emissions.
These and other features, aspects, and advantages of the present invention will become better understood with reference to the following drawings, description and appended claims.

### BRIEF DESCRIPTION OF THE SEVERAL VIEWS OF THE DRAWINGS

These and other features, aspects, and advantages of the present invention will become better understood with reference to the following drawings, description and appended claims, where:

FIG. 1 shows a front view of a torch apparatus according to an embodiment of the present invention;

FIG. 2 shows a rear view of a torch apparatus according to an embodiment of the present invention with the doors closed;

FIG. 3 shows a rear view of a torch apparatus according to an embodiment of the present invention with the doors open;

FIG. 4 shows a sectional view of a burner head assembly according to an embodiment of the present invention;

FIG. 5 shows a side view a torch apparatus according to an embodiment of the present invention that has two wheels;

FIG. 6 shows a side view of a torch apparatus according to an embodiment of the present invention that shows the torch apparatus tipped back so that the two wheels are in contact with the ground;

FIG. 7 shows a top view of a torch apparatus according to an alternative embodiment of the present invention;

### DETAILED DESCRIPTION OF THE INVENTION

In the Summary above and in the Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally. The term “comprises” and grammatical equivalents thereof are used herein to mean that other components, ingredients, steps, etc. are optionally present. For example, an article “comprising” components A, B, and C can consist of (i.e., contain only) components A, B, and C, or can contain not only components A, B, and C, but also one or more other components.

Where reference is made herein to a method comprising two or more defined steps, the defined steps can be carried out in any order or simultaneously (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1.

The term “at most” followed by a number is used herein to denote the end of a range ending with that number (which may be a range having 1 or 0 as its lower limit, or a range having no lower limit, depending on the variable being defined). For example, “at most 4” means 4 or less than 4, and “at most 40%” means 40% or less than 40%. When, in this specification, a range is given as “(a first number) to (a second number)” or “(a first number)-(a second number),” this means a range who lower limit is the first number and who upper limit is the second number. For example, 25 to 100 mm means a range who lower limit is 25 and whose upper limit is 100 mm.

The term “assembly” as used herein is intended to be understood to be used consistent with the following dictionary definition from Webster's Third New International Dictionary 131 (1986): “a collection of parts so assembled as to form a complete machine, structure, or unit of a machine”; and is NOT intended to be a “‘nonce word’ or a ‘verbal construct’ that is ‘simply a substitute for the term “means for.”’”

Any element in a claim that does not explicitly state “means for” performing a specified function, or “step for” performing a specified function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6.

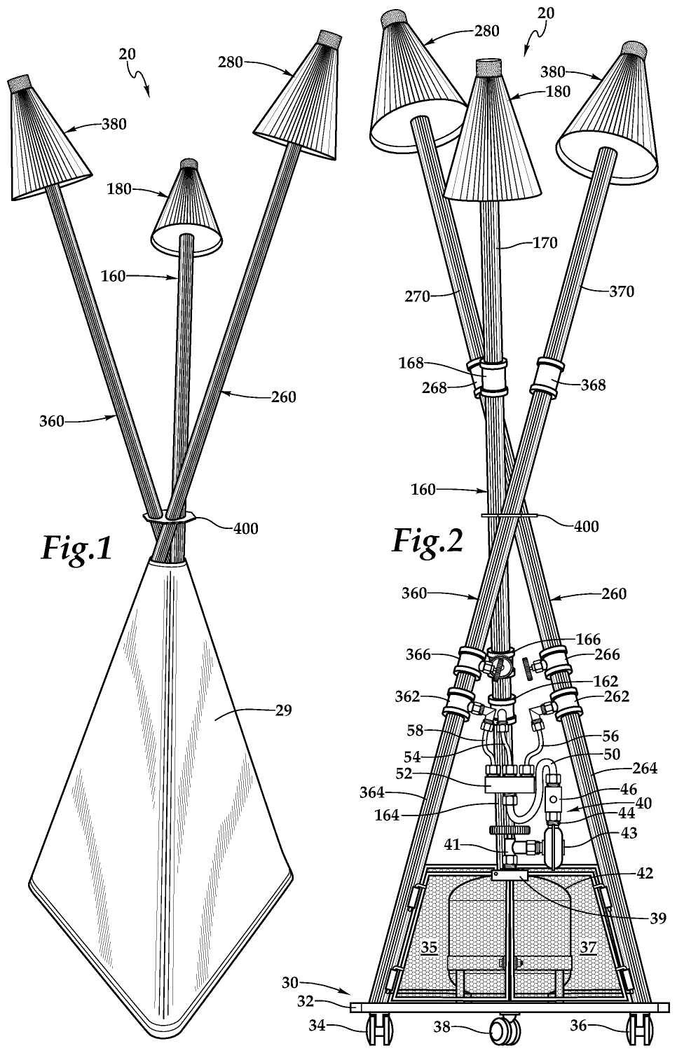

Embodiments of the present invention will now be discussed with reference to FIGS. 1 through 7.

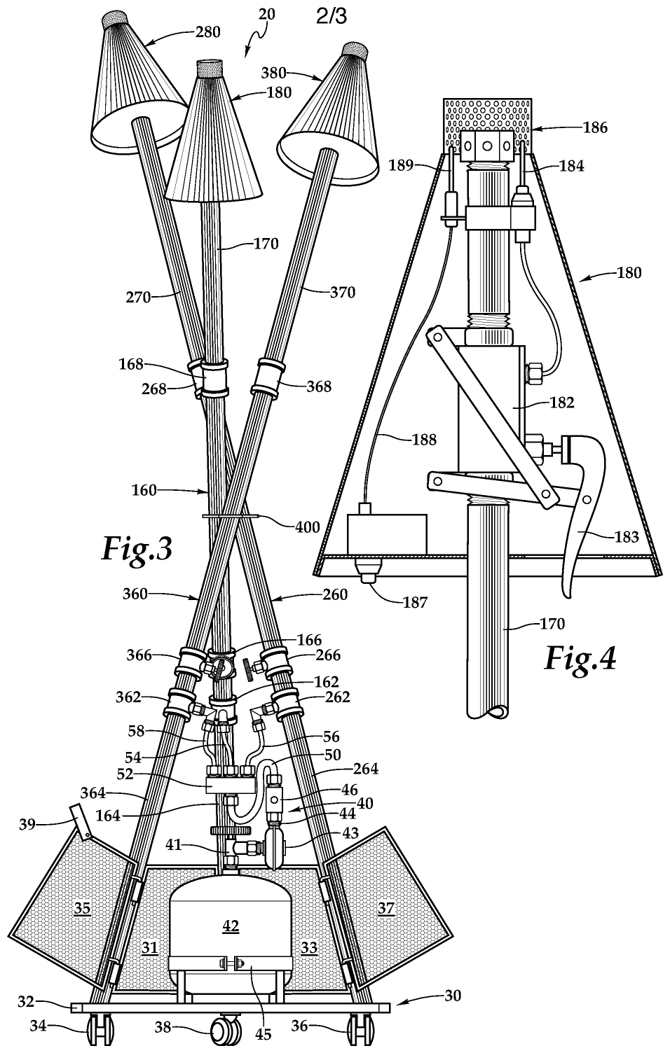

FIG. 3 depicts an embodiment of a torch assembly 20 that includes:
(i) a base assembly 30 that includes a base plate 32, a first wheel 34, a second wheel 36, and a third wheel 38;
(ii) a gas supply system 40 that includes a flammable gas source 42, a flammable gas supply connection 41, a gas pressure regulator 43, a first portion common supply line 44, a not-level shutoff valve 46, a second portion common supply line 50, a distribution header 52, a first individual supply line 54, a second individual supply line 56, and a third individual supply line 58;
(iii) a first pole assembly 160 that includes a first gas inlet 162, a first lower pole 164, a first control valve 166, a first pole connector 168, and a first upper pole 170; (Alternatively, the first pole connector 168 can be dispensed with as is depicted in FIG. 1, whereupon the first upper pole 170 would simply be part of the same pole as the first lower pole 164);
(iv) a first burner head assembly 180 connected to the top of the first pole assembly 160 that includes a first no-flame shutoff valve 182, a first bypass valve mechanism 183, a first no-flame sensor 184, a first burner tip 186, and a first ignitor assembly 188 that includes a first ignitor 189 and a first actuator 187;
(v) a second pole assembly 260 that includes a second gas inlet 262, a second lower pole 264, a second control valve 266, and a second pole connector 268, and a second upper pole 270; (Alternatively, the second pole connector 268 can be dispensed with as is depicted in FIG. 1, whereupon the second upper pole 270 would simply be part of the same pole as the second lower pole 264);
(vi) a second burner head assembly 280 connected to the top of the second pole assembly 260;
(vii) a third pole assembly 360 that includes a third gas inlet 362, a third lower pole 364, a third control valve 366, and a third pole connector 368, and a third upper pole 370; (Alternatively, the third pole connector 368 can be dispensed with as is depicted in FIG. 1, whereupon the third upper pole 370 would simply be part of the same pole as the third lower pole 364);
(viii) a third burner head assembly 380 connected to the top of the third pole assembly 360; and
(ix) connection assembly 400.

Referring to FIG. 3, the torch assembly 20 includes a first pole assembly 160, a second pole assembly 260, and a third pole assembly 360 that are each connected to a base plate 32 of a base plate assembly 30 that can include a first wheel 34 a second wheel 36 and a third wheel 38 to facilitate movement of torch assembly 20. The base plate 32 is preferably in the general shape of a triangle, with the bottom of the first pole assembly 160 attached near a first corner of the base plate 32, with the bottom of the second pole assembly 260 attached near a second corner of the base plate 32, and with the bottom of the third pole assembly 360 attached near a third corner of the base plate 32. From their bottom connection points near the three corners of the base plate 32, each of the pole assemblies angle inward and upward, crossing one another in close proximity at a point part way up where they are each connected to a connection assembly, before extending upward and outward from the connection assembly. Connection assembly 400 can be comprised of a plate that has three holes through which the poles of the first, second and third pole assemblies can pass.

Flammable gas (e.g., propane or natural gas) is supplied from flammable gas source 42 (e.g., a propane tank or a natural gas line) which is secured to the top of base plate 32 of base assembly 30. Flammable gas from flammable gas source 42 is fed through a flammable gas supply connection 41, to a gas pressure regulator 43, to a first portion common supply line 44, through a not-level shutoff valve 46, to a second portion common supply line 50, to a distribution header 52 where the flammable gas is distributed into the following three separate supply lines: a first individual supply line 54, a second individual supply line 56 and a third individual supply line 58.

Flammable gas from the first individual supply line 54 provides flammable gas to a first gas inlet 162 on a first lower pole 164 (of the first pole assembly 160), which allows flammable gas to pass upward through the first lower pole 164, through a first control valve 166, through a first pole connector 168, into a first upper pole 170 and then into a first burner head assembly 180.

The first burner head assembly, which is further depicted in the Sectional View of FIG. 4, includes a first no-flame sensor 184, a first no-flame shut-off valve 182, and a first burner tip 186. The first no-flame shut-off valve 182 is a fail-closed valve designed to fail closed in the event that the first no-flame sensor 184 fails to detect a flame (e.g., fails to detect the heat generated from a flame) at the first burner tip 186. The first no-flame sensor 184 can be a thermocouple or thermopile temperature sensing type device, or a similar such temperature sensing device. When the first no-flame sensor is a thermopile, a flame at first burner tip 186 causes the thermopile to generate electricity, which in turn allows the no-flame shut-off valve 182 to remain open, but when there is no flame the thermopile stops generating electricity which causes the no-flame shut-off valve to close. U.S. Pat. No. 2,987,566, which is incorporated herein by reference, discloses one such thermopile no-flame shut-off valve system suitable for this purpose. A first bypass valve mechanism 183 allows gas to flow through or around the first no-flame shut-off valve 182 while depressed by a person attempting to ignite flammable gas that emits from the first burner tip 186.

The first burner head assembly 180 may further include an optional a first ignitor assembly 188 that includes a first ignitor 189 and a first actuator 187. By depressing a button on the first actuator 187 a spark is generated by first ignitor 189 that in turn ignites any flammable gas being emitted from the first burner tip 186. U.S. Pat. No. 3,802,828, which is incorporated herein by reference, discloses a suitable piezo-elective ignitor suitable for this purpose. U.S. Pat. No. 3,889,160, which is incorporated herein by reference, discloses suitable battery powered ignitors suitable for this purpose.

Once the person succeeds in igniting the flammable gas emitting from the first burner tip 186, the heat from the flame will cause the no-flame sensor 184 to detect a flame, which will then allow the no-flame shut-off valve 182 to remain open, and allow the person to stop depressing the first bypass valve mechanism 183. In the event the flame at the first burner tip 186 blows out, the no-flame shut-off valve 182 will close, stopping the flow of flammable gas to the first burner tip 186. The size of the flame at the first burner tip 186 can be adjusted by adjusting control valve 166, which restricts the amount of flammable gas passing through the first control valve 166 to the first burner tip 186.

The second pole assembly 260 and second burner head assembly 280, which are depicted in FIG. 3, function in the same manner as the first pole assembly 160 and first burner head assembly 180.

Flammable gas from the second individual supply line 56 provides flammable gas to second gas inlet 262 on second lower pole 264 (of the second pole assembly 260), which allows flammable gas to pass upward through the second lower pole 264, through the second control valve 266, through a second pole connector 268, into the second upper pole 270 and then into the second burner head assembly 280.

The second burner head assembly 280 has the same components and functions in the same manner as the first burner head assembly 180.

The third pole assembly 360 and third burner head assembly 380, which are depicted in FIG. 3, function in the same manner as the first pole assembly 160 and first burner head assembly 180.

Flammable gas from the third individual supply line 58 provides flammable gas to third gas inlet 362 on third lower pole 364 (of the third pole assembly 360), which allows flammable gas to pass upward through the third lower pole 364, through control valve 366, through a third pole connector 368, into the third upper pole 370 and then into the third burner head assembly 380.

The third burner head assembly 380 has the same components and functions in the same manner as the first burner head assembly 180.

By adjusting the first control valve 166 the user can control the flame size, light, and emissions from the first burner head assembly 180. By adjusting the second control valve 266 the user can control the flame size, light, and emissions from the second burner head assembly 280. By adjusting the third control valve 366 the user can control the flame size, light, and emissions from the third burner head assembly 380. By adjusting the first control valve 166, the second control valve 266, and the third control valve 366, the user can control the total light and emissions from torch assembly 20. The three burner head design of the torch apparatus depicted in FIGS. 1-3 allows greater control of the total light, heat and emissions than a comparable single or dual burner head assembly design.

While the first control valve 166 is shown in FIG. 3 as being located in the pipe above/downstream of the first gas inlet 162, the first control valve 166 could instead be located below/upstream of the first gas inlet 162, e.g., in first individual supply line 54. Similarly, while the second control valve 266 is shown in FIG. 3 as being located in the pipe above/downstream of the second gas inlet 262, the second control valve 266 could instead be located below/upstream of the second gas inlet 262, e.g., in second individual supply line 56. Likewise, while the third control valve 366 is shown in FIG. 3 as being located in the pipe above/downstream of the third gas inlet 362, the third control valve 366 could instead be located below/upstream of the third gas inlet 362, e.g., in third individual supply line 58.

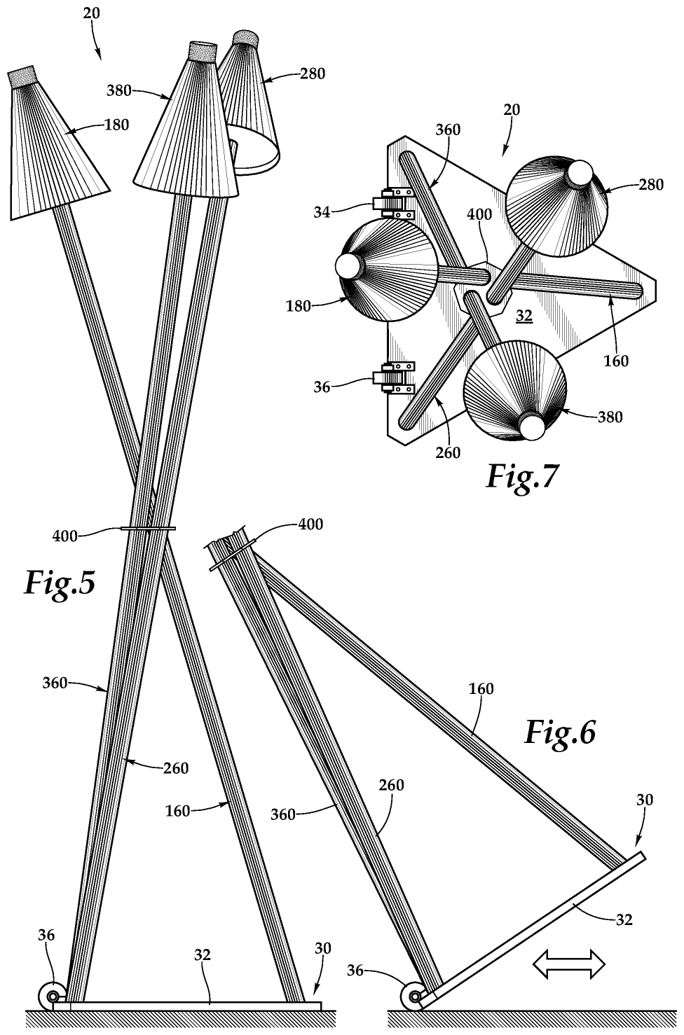

As depicted in FIGS. 5 and 6, the torch apparatus can include a first wheel 34 mounted on base plate 32 near where the third pole assembly 360 connects with base plate 32, and a second wheel 36 mounted on base plate 32 near where the second pole assembly 260 connects with base plate 32. The first wheel 34 and second wheel 36 can be mounted so that the first and second wheels are located slightly above the ground, or just touching the ground, when the torch apparatus 20 is in a fully upright position, but are fully engaged with the ground so as to allow the torch apparatus 20 to be easily moved to a different location when not lit, by rocking the torch apparatus back from vertical so that the weight of the torch apparatus 20 rests on first wheel 34 and second wheel 36. First wheel 34 and second wheel 36 are mounted to the base plate 32 so that the axis of their wheels are aligned so that each wheel rotates in a direction that is parallel with one another.

As depicted in FIGS. 2 and 3, the torch apparatus can include a first wheel 34 mounted under base plate 32 near where the third pole assembly 360 connects with base plate 32, and a second wheel 36 mounted under base plate 32 near where the second pole assembly 260 connects with base plate 32, and third wheel 38 mounted under base plate 32 near where the first pole assembly 160 connects with base plate 32. First wheel 34 and second wheel 36 are mounted to the base plate 32 so that the axis of their wheels are aligned so that each wheel rotates in a direction that is parallel with one another. The axis on which the third wheel 38 is mounted (and revolves around) can itself be rotatably mounted to the base plate 32 to which it is mounted in a swivel like manner so that the alignment of the third wheel 38 can be changed so that wheel 38 can rotate in a direction that is not parallel with first wheel 34 or second wheel 36, facilitating the ability to turn the torch apparatus 20. This arrangement allows the torch apparatus to be easily moved while still in the fully vertical position. Wheel locks as are well known in the art can be included on each wheel so that when the lock is engaged the wheel cannot rotate, thereby preventing movement of torch apparatus 20.

While torch assembly 20 has been designed to provide mobility, the user can secure torch apparatus 20 to a given fixed position (e.g., via connectors to anchors in the ground), which may be useful when the torch apparatus is to be connected to a natural gas line that is located in a fixed position (e.g., through a hole in the base plate 32).

While the dimensions and weight of the base plate can be adjusted so as to make the torch apparatus 20 resistant to turning over even in high winds, as is depicted in FIG. 3, the torch apparatus 20 may include a not-level shutoff valve 46 that includes a steel ball that rests in a lower position and allows gas to flow up and around the steel ball as long as the not-level shutoff valve 46 is in a fully vertical position. The not-level shutoff valve 46 has a valve seat located above the steel ball that remains open as long as the not-level shutoff valve 46 is in a fully vertical position, but that closes when the not-level shutoff valve is in a horizontal position because the steel ball then seats against the valve seat preventing the flow of gas. A not-level shut-off valve of the type described herein is disclosed in U.S. Pat. No. 4,380,428, which is incorporated herein by reference. With reference to FIG. 3, a tank connector 45 removably secures flammable gas source 42 to base plate 32, and the area between the bottoms of the first and second pole assemblies is partially enclosed with a first panel 33, and the first and third pole assemblies are partially enclosed with a second panel 31, and the area between the bottom of the second and third pole assemblies is partially enclosed with a first door 35 and a second door 37 that latch close with latch 39, so that in the event the torch apparatus 20 tips over the flammable gas source 42 (e.g., a propane tank) remains safely within the area between the bottom of the first, second and third pole assemblies. First panel 33, second panel 31, first door 35 and second door 37 can be made of a perforated metal that is readily permeable to the passage of air.

Referring to FIG. 3, the first upper pole 170 is removably connected to the first lower pole 164 via a first pole connector 168, so as to facilitate partial dis-assembly and movement and/or storage of the torch assembly 20. Similarly, the second upper pole 270 is removably connected to the second lower pole 264 via a second pole connector 268, so as to facilitate partial dis-assembly and movement and/or storage of the torch assembly 20. Similarly, the third upper pole 370 is removably connected to the third lower pole 364 via a third pole connector 368, so as to facilitate partial dis-assembly and movement and/or storage of the torch assembly 20 and/or to make the torch assembly more resistant to wind storms.

In an alternative embodiment the outer diameter of the first, second and third upper poles (170, 270 and 370) is slightly smaller than the inner diameter of the first, second and third lower poles (164, 264, and 364), so that each upper pole can telescope into its corresponding lower pole when the corresponding pole connector (168, 268, 368), which can be of the type disclosed in U.S. Pat. No. 3,865,410 which is incorporated herein by reference, are loosened, thereby facilitating movement and storage of the torch assembly 20 and thereby increasing the ability of the torch apparatus 20 to withstand high winds. In this same manner each individual pole assembly can be shortened or lengthened to cause the respective flames to be located at the heights most desired by the user.

FIG. 1 depicts the same torch assembly 20 that is depicted in FIG. 3, but without the pole connectors that are depicted in FIG. 3. A cover 29 encloses the lower portion of torch assembly 20. Cover 29 can be made of a flexible material, such as fabric, vinyl or leather and can include mesh portions that are readily permeable to the passage of air.

FIG. 2 depicts the same torch assembly 20 that is depicted in FIG. 3, but with first door 35 and second door 37 latched closed with latch 39.

While the above-described embodiment is described as using a propane tank, the torch apparatus could likewise be utilized with other sources of flammable gas, including natural gas (e.g., from a nearby supply line). Alternatively, flammable liquids could also be utilized to generate flames from each of the burner tips of the torch apparatus.

Although the present invention has been described with reference to certain preferred versions thereof, other versions and variations are possible.

What is claimed is:

1. A torch assembly comprising:
(a) a first pole assembly extending upward, said first pole assembly comprising:
(i) a first pole;
(ii) a first gas inlet connected to the first pole
(iii) a first burner head assembly operatively coupled to the upper end of the first pole;
(b) a second pole assembly extending upward in a different direction from the first pole assembly, said second pole assembly comprising:
(i) a second pole;
(ii) a second gas inlet connected to the second pole
(iii) a second burner head assembly connected to the upper end of the second pole;
(c) a third pole assembly extending upward in a different direction from the first pole assembly and the second pole assembly, said third pole assembly comprising:
(i) a third pole;
(ii) a third gas inlet connected to the third pole
(iii) a third burner head assembly connected to the upper end of the third pole;
(d) a base assembly that connects to a lower portion of the first pole assembly, to a lower portion of the second pole assembly, and to a lower portion of the third pole assembly;
(e) a connection assembly that is located above the base assembly, and that connects to the first pole assembly, to the second pole assembly, and to the third pole assembly;
(f) a flammable gas supply connection operatively coupled to the first gas inlet, to the second gas inlet, and to the third gas inlet.

2. The torch assembly of claim 1 wherein:
(a) the first burner head assembly further comprises:
(i) a first no-flame shut-off valve operatively coupled to the first pole;
(ii) a first burner tip operatively coupled to the first no-flame shut-off valve;
(iii) a first no-flame sensor that causes the first no-flame shut-off valve to close and stop the flow of gas to the first burner tip when the first no-flame sensor fails to detect a flame at the first burner tip;
(b) the second burner head assembly further comprises:
(i) a second no-flame shut-off valve operatively coupled to the second pole;
(ii) a second burner tip operatively coupled to the second no-flame shut-off valve;
(iii) a second no-flame sensor that causes the second no-flame shut-off valve to close and stop the flow of gas to the second burner tip when the second no-flame sensor fails to detect a flame at the second burner tip;
(c) the third burner head assembly further comprises:
(i) a third no-flame shut-off valve operatively coupled to the third pole;
(ii) a third burner tip operatively coupled to the third no-flame shut-off valve;
(iii) a third no-flame sensor that causes the third no-flame shut-off valve to close and stop the flow of gas to the third burner tip when the third no-flame sensor fails to detect a flame at the third burner tip.

3. The torch assembly of claim 1 wherein the torch assembly further comprises a not-level shut-off valve that closes and stops the flow of flammable gas to the first gas inlet when the torch assembly tips over onto its side.

4. The torch assembly of claim 2 wherein the torch assembly further comprises a not-level shut-off valve that closes and stops the flow of flammable gas to the first gas inlet when the torch assembly tips over onto its side.

5. A torch assembly comprising:
(a) a first pole assembly extending upward, said first pole assembly comprising:
(i) a first pole;
(ii) a first gas inlet connected to the first pole
(iii) a first burner head assembly connected to the upper end of the first pole;
(iv) a first control valve operatively coupled to the first burner head assembly that controls the flow of gas to the first burner head assembly;
(b) a second pole assembly extending upward in a different direction from the first pole assembly, said second pole assembly comprising:
(i) a second pole;
(ii) a second gas inlet connected to the second pole
(iii) a second burner head assembly connected to the upper end of the second pole;
(iv) a second control valve operatively coupled to the second burner head assembly that controls the flow of gas to the second burner head assembly;
(c) a third pole assembly extending upward in a different direction from the first pole assembly and the second pole assembly, said third pole assembly comprising:
(i) a third pole;
(ii) a third gas inlet connected to the third pole
(iii) a third burner head assembly connected to the upper end of the third pole;
(iv) a third control valve operatively coupled to the third burner head assembly that controls the flow of gas to the third burner head assembly;
(d) a base assembly that connects to a lower portion of the first pole assembly, to a lower portion of the second pole assembly, and to a lower portion of the third pole assembly;
(e) a connection assembly that is located above the base assembly, and that connects to the first pole assembly, to the second pole assembly, and to the third pole assembly;
(f) a flammable gas supply connection operatively coupled to the first gas inlet, to the second gas inlet, and to the third gas inlet.

6. The torch assembly of claim 5 wherein:
(a) the first burner head assembly further comprises:
(i) a first no-flame shut-off valve operatively coupled to the first pole;
(ii) a first burner tip operatively coupled to the first no-flame shut-off valve;
(iii) a first no-flame sensor that causes the first no-flame shut-off valve to close and stop the flow of gas to the first burner tip when the first no-flame sensor fails to detect a flame at the first burner tip.

7. The torch assembly of claim 5 wherein the torch assembly further comprises a not-level shut-off valve that closes and stops the flow of flammable gas to the first gas inlet when the torch assembly tips over onto its side.

8. The torch assembly of claim 6 wherein the torch assembly further comprises a not-level shut-off valve that closes and stops the flow of flammable gas to the first gas inlet when the torch assembly tips over onto its side.

9. The torch assembly of claim 6 wherein the first burner head assembly further includes an ignitor assembly.

10. The torch assembly of claim 5 wherein the torch assembly further comprises:
(a) a first wheel rotatably connected to the base assembly; and
(b) a second wheel rotatably connected to the base assembly.

11. The torch assembly of claim 10 wherein:
(a) the first burner head assembly further comprises:
(i) a first no-flame shut-off valve operatively coupled to the first pole;
(ii) a first burner tip operatively coupled to the first no-flame shut-off valve;
(iii) a first no-flame sensor that causes the first no-flame shut-off valve to close and stop the flow of gas to the first burner tip when the first no-flame sensor fails to detect a flame at the first burner tip.

12. The torch assembly of claim 10 wherein the torch assembly further comprises a not-level shut-off valve that closes and stops the flow of flammable gas to the first gas inlet when the torch assembly tips over onto its side.

13. The torch assembly of claim 11 wherein the torch assembly further comprises a not-level shut-off valve that closes and stops the flow of flammable gas to the first gas inlet when the torch assembly tips over onto its side.

14. A torch assembly comprising:
(a) a first pole assembly extending upward, said first pole assembly comprising:
(i) a first pole;
(ii) a first gas inlet connected to the first pole
(iii) a first burner head assembly connected to the upper end of the first pole;
(iv) a first control valve operatively coupled to the first burner head assembly that controls the flow of gas to the first burner head assembly;
(b) a second pole assembly extending upward in a different direction from the first pole assembly, said second pole assembly comprising:
(i) a second pole;
(ii) a second gas inlet connected to the second pole
(iii) a second burner head assembly connected to the upper end of the second pole;
(iv) a second control valve operatively coupled to the second burner head assembly that controls the flow of gas to the second burner head assembly;
(c) a third pole assembly extending upward in a different direction from the first pole assembly and the second pole assembly, said third pole assembly comprising:
(i) a third pole;
(ii) a third gas inlet connected to the third pole
(iii) a third burner head assembly connected to the upper end of the third pole;
(iv) a third control valve operatively coupled to the third burner head assembly that controls the flow of gas to the third burner head assembly;
(d) a base assembly that connects to a lower portion of the first pole assembly, to a lower portion of the second pole assembly, and to a lower portion of the third pole assembly;
(e) a connection assembly that is located above the base assembly, and that connects to the first pole assembly, to the second pole assembly, and to the third pole assembly;
(f) a flammable gas supply connection operatively coupled to the first gas inlet, to the second gas inlet, and to the third gas inlet;
(g) a first wheel rotatably connected to the base assembly;
(h) a second wheel rotatably connected to the base assembly.

15. The torch assembly of claim 14 wherein:
(a) the first burner head assembly further comprises:
(i) a first no-flame shut-off valve operatively coupled to the first pole;
(ii) a first burner tip operatively coupled to the first no-flame shut-off valve;
(iii) a first no-flame sensor that causes the first no-flame shut-off valve to close and stop the flow of gas to the first burner tip when the first no-flame sensor fails to detect a flame at the first burner tip;
(b) the second burner head assembly further comprises:
(i) a second no-flame shut-off valve operatively coupled to the second pole;
(ii) a second burner tip operatively coupled to the second no-flame shut-off valve;
(iii) a second no-flame sensor that causes the second no-flame shut-off valve to close and stop the flow of gas to the second burner tip when the second no-flame sensor fails to detect a flame at the second burner tip; and
(c) the third burner head assembly further comprises:
(i) a third no-flame shut-off valve operatively coupled to the third pole;
(ii) a third burner tip operatively coupled to the third no-flame shut-off valve;
(iii) a third no-flame sensor that causes the third no-flame shut-off valve to close and stop the flow of gas to the third burner tip when the third no-flame sensor fails to detect a flame at the third burner tip.

16. The torch assembly of claim 14 wherein the torch assembly further comprises a not-level shut-off valve that closes and stops the flow of flammable gas to the first gas inlet when the torch assembly tips over onto its side.

17. The torch assembly of claim 15 wherein the torch assembly further comprises a not-level shut-off valve that closes and stops the flow of flammable gas to the first gas inlet when the torch assembly tips over onto its side.

18. The torch assembly of claim 15 wherein the first burner head assembly further includes an ignitor assembly.

19. The torch assembly of claim 17 wherein the first burner head assembly further includes an ignitor assembly.

20. The torch assembly of claim 19 wherein the first pole further comprises a first lower pole, a first upper pole, and a first pole connector that connects the first upper pole to the first lower pole.
